(19) United States
(12) Patent Application Publication
(10) Pub. No.: US 2023/0176816 A1
(43) Pub. Date: Jun. 8, 2023

(54) COMPUTER FOR EXECUTING ALGORITHMS CARRIED OUT FROM MEMORIES USING MIXED TECHNOLOGIES

(71) Applicant: COMMISSARIAT A L’ENERGIE ATOMIQUE ET AUX ENERGIES ALTERNATIVES, PARIS (FR)

(72) Inventors: Thomas MESQUIDA, GRENOBLE (FR); François RUMMENS, GRENOBLE (FR); Laurent GRENOUILLET, GRENOBLE (FR); Alexandre VALENTIAN, GRENOBLE (FR); Elisa VIANELLO, GRENOBLE (FR)

(21) Appl. No.: 18/075,342

(22) Filed: Dec. 5, 2022

(30) Foreign Application Priority Data
Dec. 8, 2021 (FR) 2113159

(51) Int. Cl. G06F 7/48; G06N 3/042

(52) U.S. Cl. CPC G06F 7/48; G06N 3/042

(57) ABSTRACT

A computer for executing a computation algorithm involving a digital variable as per at least two operating phases is provided. The computer includes a memory stage having: a first set of memories for storing a first sub-word of each digital variable; with each memory of the first set being non-volatile and having a first read endurance and a first write cyclability; a second set of memories for storing a second sub-word of each digital variable; with each memory of the second set having a second read endurance and a second write cyclability; with the first read endurance being greater than the second read endurance and the first write cyclability being less than the second write cyclability.

### CROSS-REFERENCE TO RELATED APPLICATION

This application claims priority to foreign French patent application No. FR 2113159, filed on Dec. 8, 2021, the disclosure of which is incorporated by reference in its entirety.

### FIELD OF THE INVENTION

The invention generally relates to computers for executing a computation algorithm on digital data, and more specifically to a digital neuromorphic network computer architecture having mixed technology memory planes of at least two types. Each type of memory has a particular advantage for carrying out an operation from among training or inference operations or, more generally, an operation requiring a high number or a low number of modifications to the values computed during this operation.

### BACKGROUND

Artificial neural networks are computation models that mimic the operation of biological neural networks. Artificial neural networks comprise neurons interconnected by synapses, each synapse is attached to a weight implemented by digital memories, for example. Artificial neural networks are used in various fields of signal processing (visual, sound, or other), as in the field of image classification or image recognition, for example.

Within the context of embedded artificial intelligence, the electronic chips implementing neural networks (deep and/or pulse) require a significant memory capacity in order to store the parameters of these networks. The implementation of neural networks is divided into two phases: training and inference.

The training phase involves modifying the synaptic coefficients of the network according to a ‘training’ algorithm in order to make them converge towards values such that the network accomplishes the task for which it is trained. The inference phase involves applying computations to the input data based on the synaptic coefficients previously updated during the training phase.

In the case of a neural network accelerator, the life of the system begins with an intensive training phase. Following this training operation, the circuit carries out inference operations. As a result, artificial intelligence systems that include a training operation must also implement methods for modifying synaptic coefficients in order to respond to a given task. In terms of the problem of storing network parameters, and more specifically synaptic coefficients, the two aforementioned operations exhibit a significant difference:

during the training phase, the synaptic weights are regularly modified; therefore, the memory cells that store their values experience several iterations of intensive rewrite operations;

during the inference phase, the synaptic weights are set and the relevant memory cells no longer experience any writing action but do experience a considerable number of reading operations.

More generally, this type of difference can exist in other computation algorithms that implement several computation phases: a first phase, during which the manipulated variables experience many modifications and a second phase, during which the same variables are set or experience minimal modifications.

The various types of non-volatile memories are interesting candidates for producing the means for storing the synaptic coefficients of a neural network. However, the various non-volatile memory technologies have different features in terms of reliability and robustness when faced with a considerable number of read and write operations. In order to qualify the robustness of the various memory technologies, the following features are defined:

“write cyclability” means the maximum number of write cycles experienced by a memory cell before the structural failure thereof. It is therefore a criterion for characterizing the technological robustness of the memory cells when faced with an intense number of write operations.

“Read endurance” means the maximum number of read cycles experienced by a memory cell before the structural failure thereof. It is therefore a criterion for characterizing the technological robustness of the memory cells when faced with an intense number of read operations.

“Read energy” means the energy required to read one bit of the memory cell, it is expressed in Joules per bit. It is therefore a criterion for characterizing the energy performance capability of the memory cells when carrying out a read operation.

“Write energy” means the energy required to write a bit of the memory cell, it is expressed in Joules per bit. It is therefore a criterion for characterizing the energy performance capability of the memory cells when carrying out a write operation.

Moreover, the considerable increase in the number of read and write operations in order to implement a neural network is highly energy intensive for a system intended for a mobile application (telephony, autonomous vehicle, robotics, etc.). Therefore, a requirement exists for computers capable of implementing a neural network with limited complexity in order to meet the demands of embedded systems and targeted applications.

Within this context, a technical problem to be addressed involves improving the energy performance capability and the technological robustness of the means for storing the synaptic coefficients of a computer circuit, notably a circuit implementing a neural network capable of carrying out a training operation and an inference operation requiring a high number of write and read operations.

The scientific publication entitled, “CHIMERA: A 0.92 TOPS, 2.2 TOPS/W Edge AI Accelerator with 2 MByte On-Chip Foundry Resistive RAM for Efficient Training and Inference” by Giordano et al., describes a neural network computer circuit capable of carrying out training and inference operations, in which the storage means are produced from OxRAM oxide-based resistive memories. In order to improve the technological robustness of the means for storing synaptic coefficients, the publication proposes a training algorithm that reduces the number of write operations, thus extending the lifetime of the neural network computer circuit. The disadvantage of this solution lies in the complexity and the specificity of the training algorithm in order to reduce the number of write operations during training.

### SUMMARY

In order to address the limitations of the existing solutions with respect to improving the energy performance capability and the technological robustness of the storage means of a computer circuit intended to execute a computation algorithm on digital data, the invention proposes several embodiments of a circuit comprising at least two types of memory technologies for storing the parameters of the computer. The first type of memory exhibits high read endurance and low read energy, making it more efficient for carrying out an inference operation requiring a considerable amount of reading of synaptic coefficients.

The second type of memory exhibits high write endurance and low write energy, making it more suitable for carrying out a training operation requiring several iterations of writing synaptic coefficients.

More specifically, the invention proposes a neural network computer, by way of a non-limiting example, based on emerging non-volatile memory technologies that are complementary in terms of robustness when faced with a high intensity of read and write operations. By way of a non-limiting example, it involves combining, on the one hand, FeRAM ferroelectric polarization memories adapted for training and, on the other hand, OxRAM oxide-based resistive memories adapted for inference.

The invention also proposes a training and inference method compatible with the proposed architecture, allowing the use of one of the two types of memories to be configured so as to adapt the storage means that are used in accordance with the specific features of the operation that is carried out (inference or training).

The invention will be described within the context of an artificial neural network by way of an illustration and without loss of generality. The features of the invention remain valid for any computer for executing algorithms with two configurations (or operating phases), such that the first configuration requires a high number of operations for writing (or updating) the parameters of the computer, and such that the second configuration requires a high number of operations for reading said parameters. For a digital computation parameter, classifying bits per number of write and read operations experienced when executing a computation configuration is more generally achievable using statistics applied to test vectors.

The subject matter of the invention is a computer for executing a computation algorithm involving a digital variable as per at least two operating phases: the first operating phase comprising a plurality of iterations of a first operation for using the digital variable and an operation for updating the digital variable; the second operating phase comprising a second operation for using the digital variable;

with each digital variable being decomposed into a first binary sub-word made up of the most significant bits of the variable and a second binary sub-word made up of the least significant bits of the variable. The computer comprising:

a memory stage comprising:

a first set of memories for storing the first sub-word of each digital variable; with each memory of said first set being non-volatile and having a first read endurance and a first write cyclability;

a second set of memories for storing the second sub-word of each digital variable;

with each memory of said second set having a second read endurance and a second write cyclability;

a variable processing circuit configured to generate, for each digital variable, at least one approximated operational variable of the digital variable based on the first and the second sub-word according to the selected operating phase;

a computation network for implementing computation operations having the at least one operational variable as an operand according to the selected operating phase;

with the first read endurance being greater than the second read endurance and the first write cyclability being less than the second write cyclability.

According to a particular aspect of the invention, the first sub-word comprises N bits, the second sub-word comprises M+K bits, with M and N being two non-zero natural integers and K being a natural integer; and the K most significant bits of the second sub-word have an intersection with the same weight, with the first sub-word being repeated in the first and the second set of weight memories. The variable processing circuit comprises:

a variable reducer circuit for generating at least one first operational variable of O bits, with O being a non-zero natural integer that is less than M+N. Said first operational variable corresponding to the rounding or the truncation of the second sub-word concatenated with the N−K most significant bits of the first sub-word.

According to a particular aspect of the invention, the variable processing circuit further comprises an assembly circuit configured to generate a second operational variable of M+N bits by concatenating, for each digital variable, the second sub-word with the N−K most significant bits of the first sub-word when executing the operation for updating the digital variable.

According to a particular aspect of the invention, the computer further comprises an updating circuit configured to carry out the following steps for each digital variable for each iteration of the first operating phase, during the operation for updating the digital variable:

computing a gradient for the first operational variable;

and applying said gradient to the second operational variable;

updating the second sub-word in the second set of weight memories by copying the bits with the same weight of the second operational variable following the application of the gradient.

According to a particular aspect of the invention, the updating circuit is configured to carry out the following step for each digital variable, following the last iteration of the first operating phase:

updating the K intersection bits in the first sub-word by copying the K bits with the same weight previously updated based on the second sub-word.

According to a particular aspect of the invention, during the second operation for using the digital variable, for each digital variable:

the variable processing circuit is configured to generate a third operational variable comprising at least the sub-word;

the computation network receives the third operational variable as an operand.

According to a particular aspect of the invention, the third operational variable further comprises at least part of the second sub-word.

According to a particular aspect of the invention, the digital variable is in a floating-point format comprising a mantissa, an exponent and a sign. The first sub-word comprises at least the exponent and the sign. The second sub-word comprises at least the mantissa.

According to a particular aspect of the invention, the first set of memories is a plurality of OxRAM oxide-based resistive memories.

According to a particular aspect of the invention, the second set of memories is a plurality of FeRAM ferroelectric polarization memories.

According to a particular aspect of the invention, the FeRAM ferroelectric polarization memories and the OxRAM oxide-based resistive memories are produced on the same semiconductor substrate.

According to a particular aspect of the invention, the computer is configured to implement an artificial neural network, with the neural network being made up of a succession of layers, each being made up of a set of neurons, with each layer being associated with a set of synaptic coefficients. The digital variables are the synaptic coefficients of the neural network. The first operating phase is a training phase. The second operating phase is an inference phase. The first operation for using digital variables is a propagation of the training input data or a backpropagation of the training errors. The second operation for using digital variables is a propagation of the inference input data. The computation network is able to compute weighted sums per operational variable.

### BRIEF DESCRIPTION OF THE DRAWINGS

Further features and advantages of the present invention will become apparent from the following description, with reference to the following accompanying drawings.

FIG. 1 shows an example of a neural network containing conventional layers and fully connected layers.

FIG. 2a illustrates, on an example of a pair of fully connected neural layers belonging to a neural network, the operation of the network during an inference phase.

FIG. 2b illustrates, on an example of a pair of fully connected neural layers belonging to a neural network, the operation of the network during a backpropagation phase.

FIG. 3a illustrates a block diagram of an embodiment according to the invention of a computer configured to carry out a training operation.

FIG. 3b illustrates sub-words of a synaptic coefficient, on a binary word, distributed over the two sets of memories of the computer according to the invention.

FIG. 3c illustrates the steps of a training method executed by the neural network computer according to the invention.

FIG. 4a illustrates a block diagram of a variable processing circuit according to the invention for generating the operational variables of a synaptic coefficient.

FIG. 4b illustrates the mechanism for generating the operational variables of a synaptic coefficient according to the invention.

FIG. 5a illustrates a first example of updating the sub-words of a synaptic coefficient in the two sets of memories during a training operation.

FIG. 5b illustrates a second example of updating the sub-words of a synaptic coefficient in both sets of memories during a training operation.

FIG. 6 illustrates a block diagram of an embodiment according to the invention of a computer configured to carry out an inference operation.

FIG. 7 illustrates sub-words of a synaptic coefficient in a “floating-point” format distributed over the two sets of memories of the computer according to the invention.

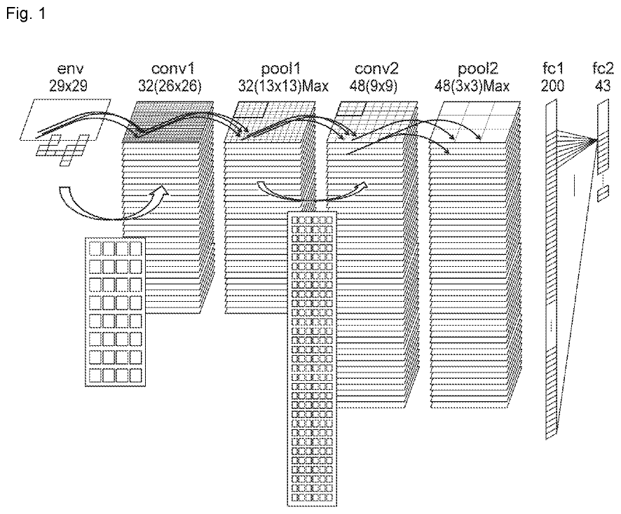

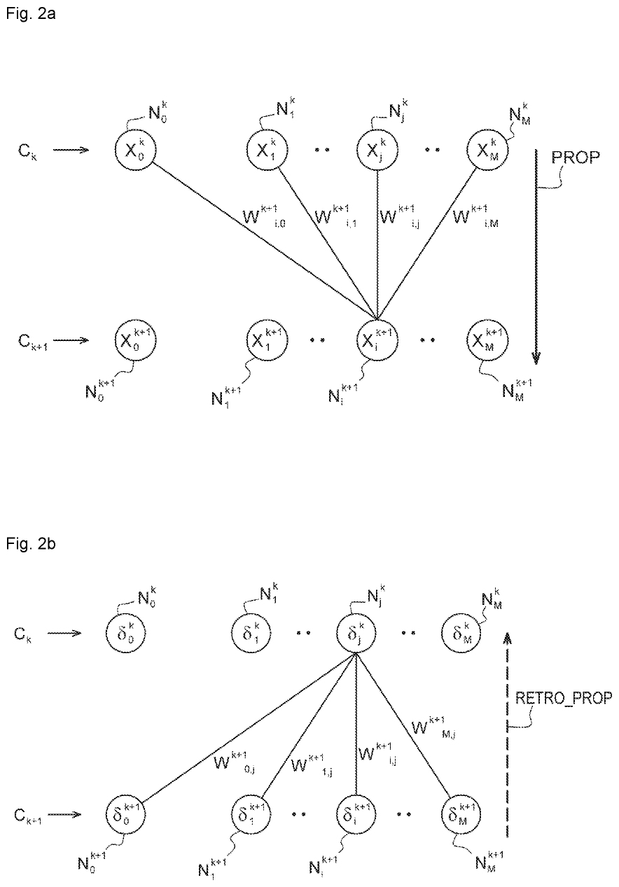

By way of a non-limiting example, an example of the overall structure of a neural network as illustrated in FIGS. 1, 2a and 2b will be described in the first instance.

### DETAILED DESCRIPTION

FIG. 1 shows the overall architecture of an example of a network for classifying images. The images at the bottom of FIG. 1 represent an extract of the convolution kernels of the first layer. An artificial neural network (also called a “formal” neural network or simply referred to as a “neural network” hereafter) is made up of one or more layers of neurons, interconnected with each other.

Each layer is made up of a set of neurons, which are connected to one or more previous layers. Each neuron in a layer can be connected to one or more neurons in one or more previous layers. The last layer of the network is called “output layer”. The neurons are connected to each other by synapses associated with synaptic coefficients, which weight the efficiency of the connection between neurons, and form the adjustable parameters of a network. The synaptic coefficients can be positive or negative.

The input data of the neural network corresponds to the input data of the first layer of the network. When passing through the succession of neural layers, the output data computed by an intermediate layer corresponds to the input data of the next layer. The output data of the last layer of neurons corresponds to the output data of the neural network. In this case, this involves the data propagating through the network in order to carry out an inference operation.

FIG. 2a shows a diagram of a pair of fully connected neural layers belonging to a neural network during an inference phase. FIG. 2a is used to understand the basic mechanisms of the computations in such layers during an inference phase, where the data propagates from the neurons of the layer Cₖ of row k to the neurons of the next layer Cₖ₊₁ of row k+1.

Following the propagation direction “PROP” shown in FIG. 2a, during an inference phase, the data Xᵢ^{k+1} associated with the neuron Nᵢ^{k+1} of the layer Cₖ₊₁ is computed using the following formula:

xᵢ^{k+1}=S(Σⱼ)xⱼ^{k}·wᵢⱼ^{k+1})+bᵢ,

with bᵢ being a coefficient called “bias” coefficient and S(x) being a non-linear function, such as a ReLu function, for example.

Thus, during an inference operation, the computer circuit carries out a high number of read operations of the synaptic coefficients from the storage means in order to compute the weighted sums described above for each neuron of each layer.

The phase for training a neural network comprises several iterations of the following operations: propagating the data from at least one sample, computing errors at the output of the network, backpropagating errors and updating the synaptic coefficients.

More specifically, the first propagation step for training involves processing a set of input images in the same way as in inference. When the last output layer is computed, the second step of computing a cost function is triggered. The result of the previous step on the last network layer is compared by means of a cost function with labelled references. The derivative of the cost function is computed in order to obtain, for each neuron of the final output layer, an error d. The next step involves backpropagating the errors computed in the previous step through the layers of the neural network from the output layer. Further information concerning this backpropagation operation will be provided in the description of FIG. 2b.

FIG. 2b shows a diagram of the same pair of neural layers described in FIG. 2a, but during a backpropagation operation. FIG. 2b is used to understand the basic mechanisms of the computations of such layers during an operation of backpropagating errors during the training phase. The data correspond to computed errors, generally denoted δᵢ, which are backpropagated from the neurons of the layer Cₖ₊₁ of row k+1 towards the neurons of the next layer Cₖ of row k. Starting in the backpropagation direction “RETRO_PROP”, during a training phase, the error δⱼ^{k} associated with the neuron Nⱼ^{k} of the layer Cₖ is computed using the following formula:

δⱼ^{k}=Σᵢ(δᵢ^{k+1}·wᵢⱼ^{k+1})·∂S(x)/∂x,

∂S(x)/∂x being the derivative of the activation function, which is equal to 0 or 1 in the event that a ReLu function is used.

The step of updating the synaptic coefficients of the entire neural network based on the results of the previous computations for each neuron of each layer involves computing, for each synaptic coefficient, an update factor

ΔWᵢⱼ^{(k)}=1/N_{batch}*Σ_{Nbatch}Xᵢ^{(k)}·δⱼ^{(k)},

with N_{batch} being the number of image samples used for the training. For each training iteration, the synaptic coefficients are rewritten in the dedicated storage means by applying the computed gradient. Thus, during a training operation, the computer circuit carries out a high number of operations for writing the synaptic coefficients in the storage means in order to update said coefficients for each neuron of each layer of the network.

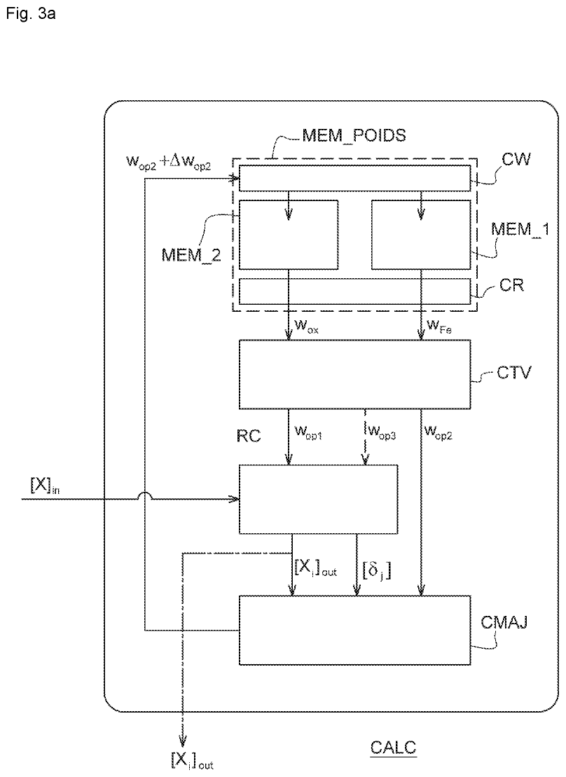

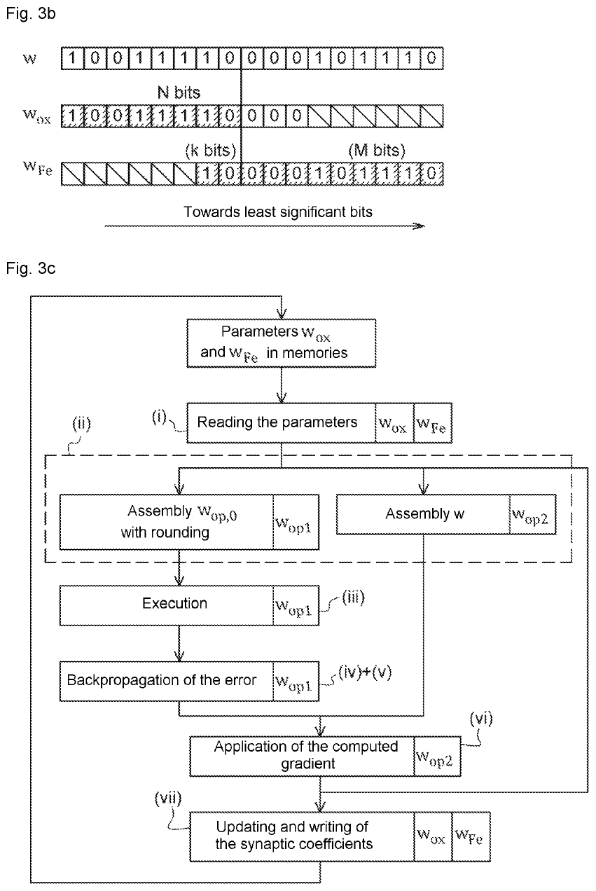

FIG. 3a illustrates a block diagram of a computer CALC, according to one embodiment of the invention, with the computer CALC being configured to carry out a training operation. The neural network computer CALC comprises a synaptic coefficient memory stage MEM_POIDS, a variable processing circuit CTV, a computation network RC and a circuit CMAJ for updating synaptic coefficients. During an inference operation, the computer CALC receives an input matrix [X]ᵢₙ comprising a plurality of input data x_{i,j} and generates an output matrix [X]ₒᵤₜ resulting from the weighted sum computations described above.

The stage comprises a first set of weight memories MEM_1, a second set of weight memories MEM_2, a circuit CR for reading from the memory points of the first or second set MEM1 and MEM2 and a circuit CW for writing to the memory points of the first or second set MEM1 and MEM2.

The first memory set MEM_1 is made up of a plurality of memory points produced using non-volatile technology and characterized by high read endurance and low read energy. Advantageously, the first memory set MEM_1 is produced by OxRAM oxide-based resistive memories, which have infinite read endurance and very low read energy of the order of 10⁻¹⁴ J/bit. The technological features of the first memory set MEM_1 allow the robustness and the energy performance capability of the synaptic coefficient memory stage MEM_POIDS to be improved during an inference operation (high number of synaptic coefficient read operations).

The second memory set MEM_2 is made up of a plurality of memory points produced using technology characterized by a higher write cyclability than the memories of the first group, and a lower write energy. Advantageously, the second memory set MEM_2 is produced by FeRAM ferroelectric polarization memories, which have write cyclability of the order of 10¹⁴ cycles and lower write energy of the order of 10⁻¹⁴ J/bit. The technological features of the second memory set MEM_2 allow the robustness and the energy performance capability of the synaptic coefficient memory stage MEM_POIDS to be improved during a training operation with updating of the synaptic coefficients (high number of synaptic coefficient write operations).

More generally, the technologies of the memories forming the first and second sets are selected so that the read endurance of the first set MEM_1 is greater than that of the second set MEM_2 and so that the write cyclability is less than the second write cyclability, in order to improve the robustness and the reliability of the means for storing the synaptic coefficients of a neural network computer with training. Furthermore, the technologies of the memories forming the first and second sets are selected so that the write energy of the second set MEM_2 is lower than that of the first set MEM_1, in order to improve the energy performance capability of the means for storing the synaptic coefficients of a neural network computer with training. This simultaneous improvement in the robustness and the energy performance capability is achieved by configuring the computer CALC to preferably use one from among the first or second memory sets, depending on the operation executed by the computer (inference or training).

In this illustrative example, and without loss of generality, the first set of memories MEM_1 is produced by a plane of OxRAM oxide-based resistive memories and the second set of memories MEM_2 is produced by a second plane of FeRAM ferroelectric polarization memories.

Alternatively, both sets of memories can be integrated in the same memory plane forming a mixed technology plane. The Fe RAM memory points and the OxRAM memory points are produced on the same semiconductor substrate and form a single matrix of memories.

In general, each synaptic coefficient is encoded on a binary word w of bits of row 1 to N+M arranged in ascending order of weight, with M and N being two non-zero natural integers. The idea behind the invention involves dividing each synaptic coefficient into two parts: a first part comprising the most significant bits and a second part comprising the least significant bits. The least significant bits are regularly modified when executing the algorithm, and are thus stored in the set of memories MEM_2 with a higher write cyclability. Conversely, the most significant bits are not modified very often and must be read more regularly when executing the algorithm, since they are the predominant bits of the synaptic coefficient. Thus, the most significant bits are stored in the set of memories with a higher read endurance.

A detailed embodiment of the decomposition of the binary word of a synaptic coefficient will now be described within the context of a neural network, with reference to FIG. 3b.

As illustrated in FIG. 3b, each synaptic coefficient w is decomposed into two sub-words wₒₓ and w_{Fe}. Each sub-word is stored in one from among the first or second set of memories MEM_1 and MEM_2 so as to use the most suitable type of memory according to the operation that is executed (inference or training).

The first sub-word wₒₓ corresponds to the most significant bits of the synaptic coefficient w and is stored in the first set of memories MEM_1. The second sub-word w_{Fe} corresponds to the least significant bits of the synaptic coefficient w and is stored in the second set of memories MEM_2.

The variable processing circuit CTV is configured to generate an operational variable (wₒₚ₁, wₒₚ₂ or wₒₚ₃), which is manipulated by the computer during the computations and which has a level of precision that can be configured according to the computation operation that is carried out by the computer CALC selected from inference (reading of w) or training, with its three operations of propagating (intensive reading of w), backpropagating (reading of w) and updating (intensive writing of w). It is therefore an operational variable corresponding to a relatively approximate value of the synaptic coefficient and is used by the computer CALC when executing a phase of the algorithm.

When producing a propagation or backpropagation algorithm during a training phase, the synaptic weights are not modified and all their dynamics, including the least significant bits, do not necessarily need to be used. On the contrary, only the most significant bits can suffice for the computations carried out as a function of the desired level of precision.

The variable processing circuit CTV thus generates a first operational variable wₒₚ₁ corresponding to an approximation of the synaptic coefficient w. The first operational variable wₒₚ₁ acts as a weighting operand when the computer CALC computes a weighted sum during training. This allows weighted sum computations to be carried out by mainly taking into account the most significant bits so as to reduce the number of read operations from the second set of memories MEM_2.

Conversely, in order to carry out an operation for updating the synaptic coefficients during training, the computer CALC needs high precision of the synaptic coefficients in order to take into account recurrent modifications of the least significant bits. The variable processing circuit CTV thus generates a second operational variable wₒₚ₂ corresponding to all the dynamics of the synaptic coefficient w. A variation is applied to the second operational variable wₒₚ₂ in accordance with a training iteration. This allows the synaptic coefficients to be precisely updated, by mainly taking into account the least significant bits, so as to reduce the number of write operations in the first set of memories MEM_1.

In order to carry out an inference phase, the computer CALC does not need high precision for the synaptic coefficients. The variable processing circuit CTV thus generates a third operational variable wₒₚ₃ corresponding to an approximation of the synaptic coefficient w. The third operational variable wₒₚ₃ acts as a weighting operand when the computer CALC computes a weighted sum during inference. This allows weighted sum computations to be carried out by mainly taking into account the most significant bits, so as to reduce the number of read operations from the second set of memories MEM_2.

The operational variables are generated from assembly, rounding and/or truncation operations of the binary sub-words wₒₓ and w_{Fe} of the synaptic coefficients distributed between the two sets of memories MEM_1 and MEM_2. It should be noted that, before starting the first training iteration, the synaptic coefficients are set to random values by way of a non-limiting example. It is possible to carry out rounding (or truncation) operations for each training iteration. Alternatively, it is possible to carry out a single rounding (or truncation) operation when transitioning from training to inference at the end of the last training iteration. This depends on the compromise that is sought between the hardware and energy demands on the computer and the precision of the computation.

The computation network RC comprises a plurality of MAC (multiplier-accumulator) type computation units capable of computing sums of the input data xᵢ (or backpropagation errors δⱼ^{k}) weighted by one of the operational variables (wₒₚ₁ or wₒₚ₃) generated by the variable processing circuit CTV according to the operation carried out by the computer CALC. Furthermore, the computation network RC receives the derivative of the cost function that is computed in order to obtain, for each neuron Nᵢ^{K} of the final output layer C_{K}, an error δᵢ^{K}. The computation operations of this step (cost function+derivation) are carried out by an embedded microcontroller (not shown) and that differs from the computer that is the subject matter of the invention.

During a training phase, the computation units of the computation network RC receive, for each synaptic coefficient, the first training operational variable woo generated by the variable processing circuit CTV as a weighting operand.

During a training operation, the circuit CMAJ for updating synaptic coefficients is configured to compute, for each synaptic coefficient, an update factor Δwₒₚ₃ from the errors δᵢ and the data xi previously computed when propagating and backpropagating the training. The gradient is applied to the second operational variable wₒₚ₂. The result of the update wₒₚ₂₊ Δwₒₚ₂ is then written to the second set of memories MEM_2 via a feedback loop connecting the updating circuit CMAJ to the write circuit CW of the memory stage MEM_POIDS.

During an inference operation, the synaptic coefficients are not updated and therefore the updating circuit CMAJ is not used. The computation units of the computation network RC receive, for each synaptic coefficient, a third operational variable wₒₚ₃ generated by the variable processing circuit CTV as a weighting operand. The third operational variable wₒₚ₃ is shown as a dashed line since FIG. 3a illustrates the configuration of the computer during a training operation.

FIG. 3b illustrates an example of sub-words for storing a synaptic coefficient w encoded on a binary word, distributed over the two sets of memories MEM_1 and MEM_2 of the computer according to the invention.

It should be noted that each synaptic coefficient w is encoded on a binary word w of bits of row 1 to N+M arranged in ascending order of significance, with M and N being two non-zero natural integers.

The N most significant bits of the binary word form a first sub-word for storing the synaptic coefficient, denoted wₒₓ. These are the bits of row M+1 to M+N. The first storage sub-word wₒₓ comprises the most significant bits that are not regularly modified during the training operation. Indeed, updating the synaptic coefficients is a high-precision operation, during which the modifications rarely affect the most significant bits. Thus, in the computer CALC according to the invention, the first storage sub-word wₒₓ of each synaptic coefficient is stored in the first set of memories MEM_1 best suited for intensive read operations.

The M+K least significant bits of the binary word w form a second storage sub-word of the synaptic coefficient, denoted w_{Fe}. These are the bits of row 1 to M+K. The second storage sub-word w_{Fe} comprises the least significant bits that are regularly modified during the training operation. Indeed, updating the synaptic coefficients is a high-precision operation, during which the modifications mainly affect the least significant bits. The second storage sub-word w_{Fe} of each synaptic coefficient in the second set of memories MEM_2 is best suited for write intensive operations.

In addition, the K most significant bits of the second storage sub-word w_{Fe} make up repeated intersection bits between the first sub-word w_{Fe} and the second sub-word wₒₓ, with K being a natural integer that is less than or equal to N. These are the bits of row M+1 to M+K that represent a repetition of the bits with the same weight of the first storage sub-word wₒₓ, but that are also stored in the second set of memories MEM_2. This intersection is the link between the bits of the first storage sub-word wₒₓ that are set during training and the bits of the second storage sub-word w_{Fe} that are regularly modified during training. When transitioning from training to inference, the content of the K bits of the intersection is copied from the second storage sub-word w_{Fe} into the bits with the same weight of the first storage sub-word wₒₓ in the first set of memories MEM_1.

FIG. 3c illustrates the steps of a training method implemented by the neural network computer CALC according to the invention.

The first step (i) involves reading, for each synaptic coefficient w_{i,j}: the first storage sub-word wₒₓ from the first set of weight memories MEM_1 and reading the second storage sub-word w_{Fe} from a second set of weight memories MEM_2. This step is implemented by the read circuit CR controlled by control means.

The second step (ii) involves generating the first operational variable woo and the second operational variable wₒₚ₂ from the first and second sub-words of said synaptic coefficient w.

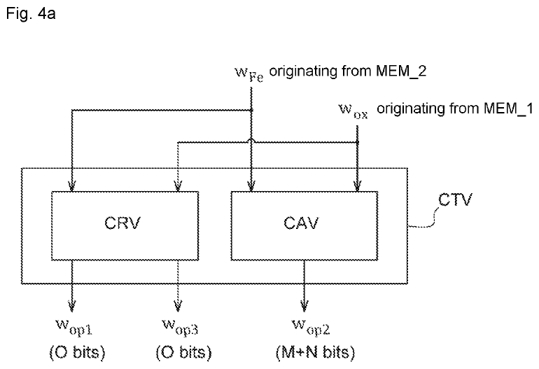

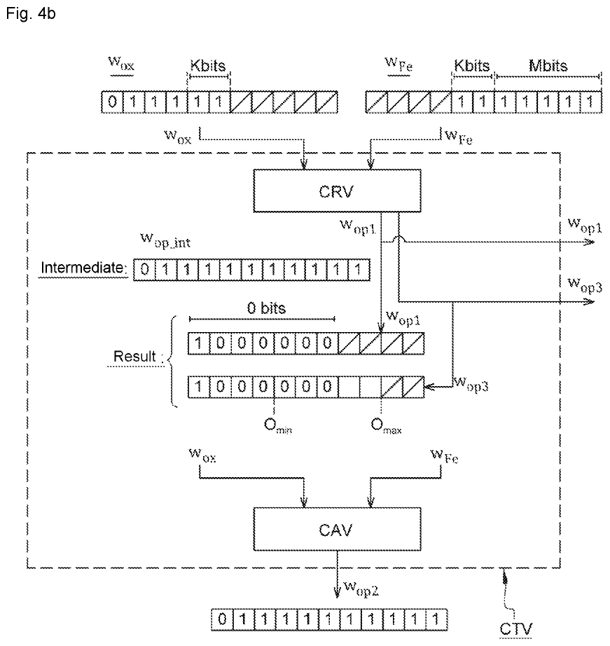

In order to describe the sequence of the second step (ii), FIGS. 4a and 4b respectively show a block diagram of the variable processing circuit CTV and the mechanism for generating the first operational variable wₒₚ₁ made up of O bits, with O being a natural integer that is less than M+N, and of the second operational variable wₒₚ₂ made up of M+N bits.

In FIG. 4a, the variable processing circuit CTV comprises a variable reducer circuit CRV for computing the first operational variable wₒₚ₁ from the first and the second storage sub-words (w_{Fe} and wₒₓ) by carrying out rounding or truncation operations. The variable processing circuit CTV further comprises an assembly circuit CAV capable of concatenating sub-words in order to generate operational variables used in the various operating phases of the neural network. The assembly circuit CAV is configured to compute the second operational variable wₒₚ₂ from the first and the second storage sub-words w_{Fe} and wₒₓ.

In FIG. 4b, the variable reducer circuit CRV receives, for each iteration, the first storage sub-word wₒₓ of N bits originating from the first set of memories MEM_1 and the second storage sub-word w_{Fe} of M+K bits originating from the second set of memories MEM_2 in order to compute an intermediate variable w_{op_int} encoded on M+N bits. The intermediate variable w_{op_int} is obtained by concatenating the two received sub-words with the preponderance of the second storage sub-word w_{Fe} for the intersection bits. Then, the variable reducer circuit CRV generates the first operational variable wₒₚ₁ corresponding to the rounding (or truncation) of the intermediate variable w_{op_int} on the O most significant bits. This provides an operational variable approximating the synaptic coefficient that can be used for propagating and backpropagating through the neural network during a training iteration.

Moreover, for each training iteration, the second operational variable wₒₚ₂ is generated by the assembly circuit CAV on M+N bits and is obtained by concatenating the N−K bits of the first storage sub-word wₒₓ originating from the first set of memories MEM_1 with the M+K bits of the second storage sub-word w_{Fe} originating from the second set of memories MEM_2. This results in an operational variable with a precision level that is greater than wₒₚ₁ of the synaptic coefficient that can be used for the updating phase at the end of the training iteration.

The third step (iii) involves carrying out data propagation of a sample through the neural network, weighted by the first operational variables woo. The computation units of the computation network RC receive, for each synaptic coefficient, the first operational variable wₒₚ₁ generated by the variable processing circuit CTV as a weighting operand.

The fourth step (iv) involves computing errors δ at the output of the last layer of neurons, as explained above.

The fifth step (v) involves backpropagating errors δᵢ, through the neural network, weighted by the first operational variables wₒₚ₁ and computing a gradient for each first operational variable wₒₚ₁ following a backpropagation of errors. The computation units of the computation network RC receive, for each synaptic coefficient, the first operational variable wₒₚ₁ generated by the variable processing circuit CTV as a weighting operand.

The sixth step (vi) involves applying an error gradient to each second operational variable wₒₚ₂ that results from the backpropagation step. This step is implemented by the circuit for updating synaptic coefficients. Applying the gradient Δwₒₚ₂ allows the modifications to be applied to the least significant bits and therefore allows maximum precision to be obtained during the update.

The last step (vii) involves updating the second storage sub-word w_{Fe} in the second set of weight memories MEM_2 for each synaptic coefficient via the feedback loop linking the updating circuit CMAJ to the write circuit CW.

The aforementioned sequence of steps is repeated several times for each training input sample until they converge at an equilibrium point. For each iteration, the memories of the second set MEM_2 are the only memories to be rewritten during the updating step. This allows the significant write cyclability of, for example, FeRAM memories to be taken advantage of and allows wear on, for example, OxRAM type memories to be minimized by reducing the number of writes to this type of memory to a minimum. In addition, the low write energy of the second set of memories MEM_2 allows energy consumption to be reduced during training and more specifically when updating synaptic weights.

Alternatively, the last step (vii) further comprises write operations in the least significant bits of the first storage sub-word wₒₓ in the first set of weight memories MEM_1 if the application of the gradient Δwₒₚ₂ in the previous step (vi) modifies at least one bit with an order that is greater than N+K.

The intermediate operation of transitioning from training to inference in order to use the neural network computer that has finalized its training will be described hereafter. The state of the sub-words is shown.

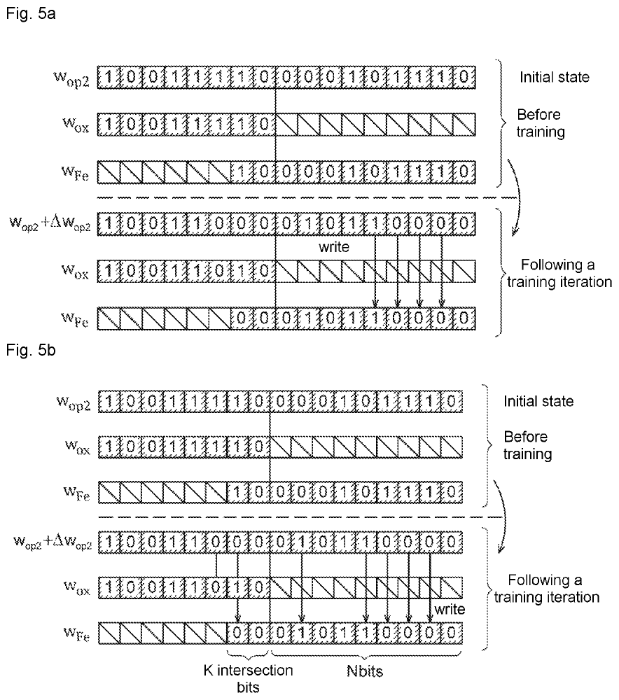

FIG. 5a describes a first example of updating the sub-words of a synaptic coefficient in the two sets of memories at the end of a training iteration. This is the intermediate step between the last training iteration and the start of inference or an intermediate step between two successive training iterations.

The modifications made to the synaptic coefficients of the network are small, and only the least significant bits of w_{Fe} are rewritten after N training iterations. The most significant bits of the operational variable wₒₚ₂ are not modified following the training phase, thus no writing is carried out on the M most significant bits of MEM_1 nor on the K intersection bits in the second set of memories MEM_2.

FIG. 5b describes a second example of updating the sub-words of a synaptic coefficient in both sets of memories at the end of a training iteration. This is the intermediate step between the last training iteration and the start of inference or an intermediate step between two successive training iterations.

In the second case, the magnitude of the modifications of the least significant bits of w_{Fe} during training modifies the K intersection bits in the second memory set MEM_2. During the updating operations for each iteration, only the K intersection bits stored in the second set of memories MEM_2 (therefore of w_{Fe}) are rewritten. The K intersection bits of the first storage sub-word wₒₓ remain unchanged during the training phase.

At the end of the training method, and during the transition from training to inference, a discrepancy can be seen between the K first bits of the first storage sub-word wₒₓ (not modified during the update) and the K bits of the second storage sub-word w_{Fe} (modified during the update) for the same bits of the synaptic coefficient. In this case, the write circuit CW is configured to copy the K modified bits of the second storage sub-word w_{Fe} into the first set of memories MEM_1 comprising the first storage sub-word wₒₓ. Thus, the number of write operations to the first storage sub-word wₒₓ is minimized since, during training iterations, the probability of rewriting is greater for the bits stored in the second set of memories MEM_2. This avoids wear on the memories of the first set MEM_1, which have a lower write cyclability than the memories of the second set MEM_2.

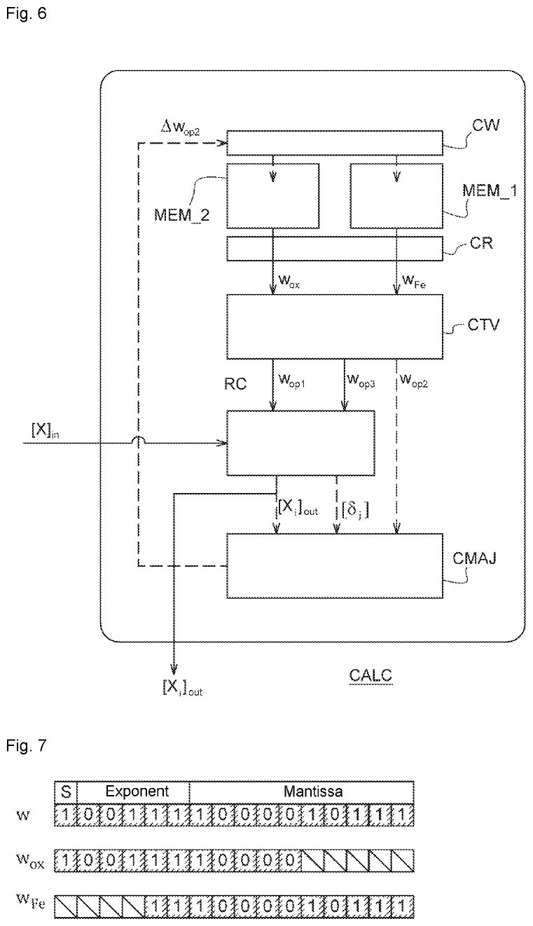

FIG. 6 illustrates a block diagram of a computer CALC configured to carry out an inference operation, according to one embodiment of the invention. Thus, the configuration of the stream of data in the computer CALC can be seen such that the computation units of the computation network RC receive, for each synaptic coefficient, the third operational variable wₒₚ₃ generated by the variable processing circuit CTV as a weighting operand, as illustrated in FIG. 4b.

The third operational variable wₒₚ₃ comprises the O most significant bits of the synaptic coefficient w and therefore comprises at least part of the first storage sub-word wₒₓ and therefore of the data exclusively read from the first set of memories MEM_1.

In the case whereby the size of the third operational variable wₒₚ₃ is selected such that O<N, the read operations are minimized and read operations are exclusively carried out from the first set of memories MEM_1. This is the most advantageous configuration in terms of technical robustness (lifetime of the storage means) and energy consumption. However, there is a loss of precision during inference since the size of the third operational variable wₒₚ₃ is limited.

In the case whereby the size of the third inference operational variable wₒₚ₃ is selected such that O>N, read operations are carried out from all the memories of the first set of memories MEM_1, but also from part of the data from the memories of the second set of memories MEM_2. This is the most advantageous configuration in terms of computing performance and precision. However, this configuration is less advantageous than the previous configuration in terms of technical robustness and energy consumption.

In this way, the precision of the synaptic coefficients can be increased for critical inference in order to achieve better results. For this to be effective, a low precision Oₘᵢₙ training run initially needs to be completed. Once this training is complete, a higher precision training run Oₘₐₓ needs to be completed while setting the O_{faible} bits. In this way, the network using Oₘᵢₙ bits always has the same performance capabilities. The network using Oₘₐₓ bits can attempt to be refined within this limit.

Advantageously, the size of the third operational variable wₒₚ₃ is selected such that O=N, so as to use all the bits stored in the high read endurance memories. This is an optimal configuration with a compromise between computation precision during inference and improved technical robustness of the storage means during training.

Design variants of the computer according to the invention will be described hereafter according to the selection of the number of intersection bits K between the first storage sub-word wₒₓ and the second storage sub-word w_{Fe}.

In the case whereby K=O, there are no repeated bits between the words wₒₓ, and w_{Fe}. This variant has the advantage of minimizing the surface area of the second set of memories MEM_2. None of the bits of a synaptic coefficient are repeated, this is the configuration that offers a reduction in the surface area of the computer. Conversely, said configuration requires more write operations on the memories of the first set MEM_1 during training.

In the case whereby K=N, the bits stored in wₒₓ are entirely repeated in w_{Fe}. This variant has the advantage of not requiring any OxRAM writing during the cycles of a training phase. Conversely, this variant requires a larger surface area for the second set of memories MEM_2. This memory set is no longer used during inference and this leaves a large surface area of the circuit inactive during the lifetime of the computer.

FIG. 7 illustrates sub-words of a synaptic coefficient in a “floating-point” format distributed over the two sets of memories of the computer according to the invention.

Without loss of generality, the computer CALC circuit according to the invention is also compatible with encoding of the synaptic coefficients in a “floating-point” format. In this case, the binary word comprises a mantissa, an exponent and a sign. The set of mantissa bits exhibits high variability during training. The set of sign and exponent bits experience far less modifications during training. Thus, within the scope of the invention it is possible to contemplate distributing the binary word of each synaptic coefficient as follows:

a first storage sub-word wₒₓ in the first memory set MEM_1 comprising at least the bits of the exponent and the sign;

a second sub-word storing the synaptic coefficient w_{Fe} in the second memory set MEM_2 comprising at least the mantissa.

All the features and data processing described above remain valid for the embodiment with encoding in a “floating-point” format.

Although the invention has been described within the scope of application to a neural network computer, it similarly applies to any computer implementing a computation algorithm comprising at least two computation phases respectively involving many and few modifications of the values of the operands manipulated during the computation phases.

1. A computer (CALC) for executing a computation algorithm involving a digital variable (w) as per at least two operating phases:
the first operating phase comprising a plurality of iterations of a first operation for using the digital variable and an operation for updating the digital variable;
the second operating phase comprising a second operation for using the digital variable;
with each digital variable being decomposed into a first binary sub-word (wₒₓ) made up of the most significant bits of the variable and a second binary sub-word (w_{Fe}) made up of the least significant bits of the variable, the computer (CALC) comprising:
a memory stage (MEM_POIDS) comprising:
a first set of memories (MEM_1) for storing the first sub-word (wₒₓ) of each digital variable (w); with each memory of said first set (MEM_1) being non-volatile and having a first read endurance and a first write cyclability;
a second set of memories (MEM_2) for storing the second sub-word (w_{Fe}) of each digital variable (w);
with each memory of said second set having a second read endurance and a second write cyclability;
a variable processing circuit (CTV) configured to generate, for each digital variable (w), at least one approximated operational variable (wₒₚ₁, wₒₚ₂, wₒₚ₃) of the digital variable based on the first and the second sub-word (wₒₓ, w_{Fe}) according to the selected operating phase;
a computation network (RC) for implementing computation operations having the at least one operational variable wₒₚ₁, wₒₚ₂, wₒₚ₃) as an operand according to the selected operating phase;
with the first read endurance being greater than the second read endurance and the first write cyclability being less than the second write cyclability.

2. The computer (CALC) according to claim 1, wherein
the first sub-word comprises N bits, the second sub-word comprises M+K bits, with M and N being two non-zero natural integers and K being a natural integer;
and wherein the K most significant bits of the second sub-word (w_{Fe}) have an intersection with the same weight, with the first sub-word (wₒₓ) being repeated in the first and the second set of weight memories (MEM_2, MEM_1),
the variable processing circuit (CTV) comprising:
a variable reducer circuit (CRV) for generating at least one first operational variable (wₒₚ₁, wₒₚ₃) of O bits, with O being a non-zero natural integer that is less than M+N; with said first operational variable (wₒₚ₁) corresponding to the rounding or the truncation of the second sub-word (w_{Fe}) concatenated with the N−K most significant bits of the first sub-word (wₒₓ).

3. The computer (CALC) according to claim 2, wherein the variable processing circuit (CTV) further comprises an assembly circuit (CAV) configured to generate a second operational variable (wₒₚ₂) of M+N bits by concatenating, for each digital variable (w), the second sub-word (w_{Fe}) with the N−K most significant bits of the first sub-word (wₒₓ) when executing the operation for updating the digital variable.

4. The computer (CALC) according to claim 3, further comprising an updating circuit (CMAJ) configured to carry out the following steps for each digital variable (w) for each iteration of the first operating phase, during the operation for updating the digital variable:
computing a gradient for the first operational variable (wₒₚ₁);
and applying said gradient to the second operational variable (wₒₚ₂),
updating the second sub-word (w_{Fe}) in the second set of weight memories (MEM_2) by copying the bits with the same weight of the second operational variable (wₒₚ₂) following the application of the gradient.

5. The computer (CALC) according to claim 4, wherein, following the last iteration of the first operating phase, the updating circuit (CMAJ) is configured to carry out the following step for each digital variable:
updating the K intersection bits in the first sub-word (wₒₓ) by copying the K bits with the same weight previously updated based on the second sub-word (w_{Fe}).

6. The computer (CALC) according to claim 2, wherein, during the second operation for using the digital variable, for each digital variable:
the variable processing circuit (CTV) is configured to generate a third operational variable (wₒₚ₃) comprising at least the sub-word (wₒₓ);
the computation network (RC) receives the third operational variable (wₒₚ₃) as an operand.

7. The computer (CALC) according to claim 6, wherein the third operational variable (wₒₚ₃) further comprises at least part of the second sub-word (w_{Fe}).

8. The computer (CALC) according to claim 1, wherein the digital variable (w) is in a floating-point format comprising a mantissa, an exponent and a sign;
and wherein the first sub-word (wₒₓ) comprises at least the exponent and the sign;
the second sub-word (w_{Fe}) comprises at least the mantissa.

9. The computer (CALC) according to claim 1, wherein the first set of memories (MEM_1) is a plurality of OxRAM oxide-based resistive memories.

10. The computer (CALC) according to claim 1, wherein the second set of memories (MEM_2) is a plurality of FeRAM ferroelectric polarization memories.

11. The computer (CALC) according to claim 9, wherein the second set of memories (MEM_2) is a plurality of FeRAM ferroelectric polarization memories, wherein the FeRAM ferroelectric polarization memories and the OxRAM oxide-based resistive memories are produced on the same semiconductor substrate.

12. The computer (CALC) according to claim 1, configured to implement an artificial neural network, with the neural network being made up of a succession of layers (Cₖ, Cₖ₊₁), each being made up of a set of neurons, with each layer being associated with a set of synaptic coefficients (w_{i,j}), wherein:
the digital variables are the synaptic coefficients of the neural network;
the first operating phase is a training phase;
the second operating phase is an inference phase;
the first operation for using digital variables is a propagation of the training input data (w_{i,j}) or a backpropagation of the training errors (δ);
the second operation for using digital variables is a propagation of the inference input data;
the computation network (RC) is able to compute weighted sums per operational variable wₒₚ₁, wₒₚ₂, wₒₚ₃).
